(19) United States
(12) Patent Application Publication
(10) Pub. No.: US 2007/0042075 A1
(43) Pub. Date: Feb. 22, 2007

(54) Fast thermal response mold

(76) Inventor: Christopher Cavallaro, Lakeville, MA (US)

Correspondence Address: ACUSHNET COMPANY, 333 BRIDGE STREET, P. O. BOX 965, FAIRHAVEN, MA, 02719, US

(21) Appl. No.: 11/208,583

(22) Filed: Aug. 22, 2005

(51) Int. Cl. B29C 45/00

(52) U.S. Cl. 425/542

(57) ABSTRACT

An improved mold frame for making a fast thermal response mold is disclosed. The mold frame has a plurality of rows with each row having a plurality of cavities. The mold frame is constructed of two half-molds, each half-mold containing an upper and lower plate vacuum brazed together to form flow channels that allow thermal mediums to pass in close proximity to the cavity. Without any direct contact between the flow mediums and the cavities the necessity for O-rings is eliminated. Without O-rings the compression molding of thermoplastic materials may be at temperatures greater than 300° F.

### FIELD OF THE INVENTION

This invention relates to a mold and, more particularly, to a mold having a flow path for the thermal medium that minimizes the heat transfer distance and eliminates the need for O-rings.

### BACKGROUND OF THE INVENTION

The present invention relates to improvement to molds, such as that disclosed in U.S. Pat. Nos. 5,795,529, 5,725,891, 4,895,293, 4,757,972, and 4,508,309, all of which are assigned to the Acushnet Company and are incorporated herein by reference. These patents are directed to molds holding a plurality of cavities in the mold frame to accommodate gold ball half-molds and disposed in a closely packed arrangement.

In compression molding of items such as golf balls, the molding of golf balls is normally accomplished in a mold assembly comprising of a pair of mold plates, each of which comprises a plurality of individual molds or mold cups within a mold frame. The mold frame has a plurality of openings for receiving the individual molds or mold cups. This allows for individual molds/cups to be replaced if they become damaged or worn without the need to replace the entire assembly. Next, a plurality of preformed golf ball cover half-shells are placed about the ball cores within the mold cups. The mold plates are then joined to form the mold assembly wherein the cover shells and ball core are subjected to heat and pressure to melt the cover stock so that it flows evenly about the core, therein molding the cover about the core. After this step the mold is then preferably cooled, which in turn causes the cover stock to cool and solidify before the mold is reopened.

U.S. Pat. No. 4,508,309 teaches an apparatus and method for making a fast thermal response mold assembly where the mold cups themselves are in direct contact with the thermal fluid used to heat and cool the mold. It is thus unnecessary to heat and cool the entire frame to change the temperature of the molds. Although the invention taught by the '309 patent was considered a major breakthrough for the golfing industry, such a mold assembly is subject to mechanical problems. For example, it has been discovered that in commercial practice the O-ring which provides the seal between the mold assembly and the mold half may sometime begin to leak very soon after installation. Another problem is that generally the thermal medium used to heat the mold is steam, and escaping steam from these mold assemblies can make working around such assemblies quite dangerous and also requires frequent maintenance and downtime to keep replacing O-rings. Of particular concern with this design is that the thermal fluid is in direct contact with the cavity.

It has now been discovered that leakage problems can be solved by placing a thin, metal sleeve with good conductive capability inside the cavity of the mold frame to completely seal the cavity, as seen in U.S. Pat. No. 4,895,293. It has been found that such a sleeve does not materially affect the thermal response of the mold. Such a sleeve has been found to alleviate the leakage problem by eliminating O-rings and cross-bores that connect individual flow channels.

The mold frames of the prior art are comprised of mold plates that are held in opposing abutment during the molding operation. Half-molds are disposed in the cavities to be held in opposed abutment to form golf balls from ball assemblies. The thermal medium that enters the mold frames flow in a serpentine flow pattern flow around each of the half-molds to provide the heating or cooling thereof. As the thermal medium flows past each half-mold there is a transfer of thermal energy under the principles of forced convection and conduction. Thus, the half-molds will lose heat and the cooling fluid will gain heat. Therefore, the cooling fluid will be at a higher temperature as it flows around each later half-mold in the flow path and the efficiency of the cooling fluid to cool the later half-mold is reduced. Thus, when heating or cooling these molds, there existed a substantial temperature differential between the first and last half-mold in the serpentine flow path. One problem that exists with this type of mold is that to properly melt the golf ball cover material, the mold has to be preheated. Preheating the mold to the melting temperature helps insure that the molding of the golf balls is uniform. However, preheating the mold adds to the molding cycle time and makes loading the half-molds difficult. It also must be appreciated that the mold operator has to manually load the ball assemblies into the half-molds. Thus, from an operator's standpoint, it is much more advantageous to load the half-molds when the mold is cold rather than hot.

In order to properly mold golf balls in the prior art mold, the process comprises the steps of preheating the mold, loading half-molds, melting the golf ball cover material with hot thermal medium, cooling the golf balls with cold thermal medium and finally unloading the mold. Clearly, the preheating step creates inefficiency in the process, in that the mold has to be opened twice to unload and load the half-molds.

In U.S. Pat. Nos. 5,795,529 and 5,725,891, an improvement was made to the above prior art patents, in that the mold was configured so as to improve the flow path for the thermal medium. These patents taught the division of flow paths into a plurality of parallel flow paths, wherein water enters the mold and flows through only one row of half-molds. This design reduced the maximum number of flow paths therein reducing the response delay between the first and last half-mold and the time/temperature response of all half molds in the mold would be more uniform. However, these designs require the use of O-rings and also that the thermal fluid be in direct contact with the cavity. Generally, the use of O-rings limits the compression molding of golf ball cores or thermoplastic covers to temperatures less than 300° F.

It would be a significant improvement of the prior art to have a mold designed for fast thermal response compression molding of golf ball cores or thermoplastic covers at temperatures higher than 300° F.

### SUMMARY

The invention is an improvement to the mold frame described above. More particularly, the invention is a mold configured to have an improved flow path for the thermal medium. The invention is directed to dividing the flow path through the mold for the thermal medium into a plurality of parallel flow paths, i.e., water entering the mold flows through only one row of half-molds. In this manner, the maximum number of half-molds in any one flow path is reduced. Thus, the thermal medium will flow around a reduced number of half-molds and the thermal response delay between the first and last half-mold is thereby reduced. The time/temperature response of all half-molds in the mold is also more uniform.

In an embodiment of the invention, the mold frame includes two inlets. The thermal medium enters the mold through the inlets and divides to flow through the rows of half-molds. The total thermal medium that enters each inlet will flow through approximately ½ of the rows of half-molds. However, any portion of the thermal medium will only flow around half-molds in one row which is substantially less than the serpentine flow path. Thus, the temperature change and the pressure drop of the thermal medium from when it flows around the first half-mold to when it flows around the last half-mold in its flow path is greatly reduced over the prior art.

In another embodiment of the invention, the flow path is divided into parallel flow paths equal to the number of cavity rows. Thus, the number of inlets and cavity rows are the same, and the flow enters the mold plates, flows across only one row of mold cavities and half-molds, and exits the mold. In this embodiment, there isn't any pressure drop in the mold plates for flow diversion, thus, the temperature change and the pressure drop of the thermal medium from when it flows around the first half-mold to when it flows around the last half-mold is greatly reduced over the prior art.

The present invention is also directed to an improved method of operating the mold. The method incorporates flowing thermal medium in parallel paths through the half-mold rows. More particularly, the method includes substantially increasing the thermal medium volume flow rate through the entire mold, but maintaining the same flow velocity through each half-mold row. Since the flow path length and complexity is reduced through the mold, the pressure drop through the mold is substantially decreased. Thus, the amount of thermal medium flowing through the mold is increased, but the energy required to produce the flow is substantially the same. Thereby, the mold efficiency is greatly increased and the power required to operate the mold remains substantially constant. Furthermore, the method of operating the mold includes unloading and loading the half-molds from the mold while the mold is in the cold state. The method is comprised of the steps of cooling the mold by flowing cold thermal medium such as cold water through it, unloading and loading under cool conditions, purging the cold thermal medium with compressed air, flowing hot thermal medium such as steam through the half-mold rows to mold the cores and flowing cold thermal medium through the half-mold rows to cool the cores.

### BRIEF DESCRIPTION OF THE DRAWINGS

FIG. 1 is a plan view of a typical mold frame depicting the arrangement for a plurality of cavities holding golf ball half molds (not shown).

FIG. 2 is a plan view of the upper plate making up a half of a mold with the flow pattern depicted for two cavities.

FIG. 3 is an elevational end view of FIG. 2.

FIG. 4 is a plan view of the mating side of the lower plate that makes up a half of a mold with the flow pattern depicted

FIG. 5 is an elevational end view of FIG. 4.

FIG. 6 is an expanded view of the lower and upper plates that form half a mold.

FIG. 7 is an end view of the lower and upper plates brazed together to form the half mold.

FIG. 8 is a cross-sectional view of the mold halves merged together.

FIG. 9 is cross section-view of an embodiment wherein the cavities each contain removable cups.

### DETAILED DESCRIPTION OF THE INVENTION

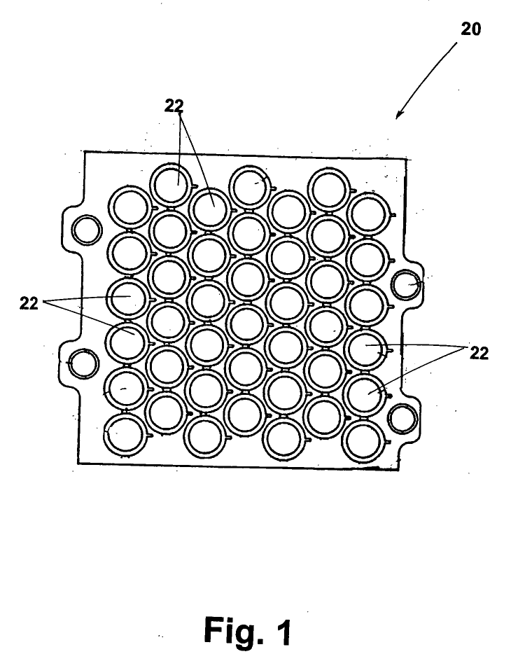

Referring first to FIG. 1, there is shown a standard mold frame such as is used in the prior art for the compression molding of golf balls. The frame 20 is provided with a plurality of cavities 22 in which are secured standard golf ball half molds. The frame 20 has a plurality of couplings (not shown) for introducing a thermal medium such as steam, or cooling liquid (water), introduced through the coupling and withdrawn through similar couplings (also not shown). In previous molds, In order to heat or cool the mold disposed in each individual cavity, it was necessary to heat or cool the mass of metal in the mold frame between the cavities to the temperature of the thermal medium passing through the mold frame.

The present invention describes a pair of cavities 22 that represent a plurality of cavities 22 for accommodating golf ball half-molds, a top half-mold 24 and a bottom half-mold 26, are disposed in the mold frame 20 in a preferably closely packed arrangement such as shown in FIG. 1. A closely packed arrangement is defined herein as one in which the distance between lines connecting the centers of the cavities 22 in each row is less than 2 times the radius of the cavities 22. It is preferred that the spacing between rows of cavities 22 be in the range of less than about 1.25 the radius of the cavities 22. It is to be appreciated that other arrangements may be utilized, but the arrangement illustrated is preferred in order to take advantage of the fact that less space is required in a mold frame 20 in accordance with the invention. The closely packed arrangement enables an increased number of balls to be molded in a press of predetermined size, thus increasing productivity and reducing energy consumption.

The present invention avoids the serpentine flow pattern of previous molds, wherein as the medium flows through the mold frame to provide heating or cooling, and the transfer of energy being greater and much more efficient at the first cavities encountered than at later cavities. There is a substantial temperature difference between the first cavity encountered and the final cavity heated or cooled. One problem that has existed with this type of mold is that to properly melt the golf ball cover material, the mold had to be preheated. Preheating the mold to the melting temperature of the cover material helps insure that the molding of the golf balls is uniform. However, preheating the mold adds to the molding cycle time and makes loading the half-molds difficult. It also must be appreciated that the mold operator has to manually load the ball assemblies into the half-molds. Thus, from an operator's standpoint, it is much more advantageous to load the half-molds when the mold is cold rather than hot.

As previously stated, to properly mold golf balls in the prior art mold, the process comprises the steps of preheating the mold, loading half-molds, melting the golf ball cover material with hot thermal medium, cooling the golf balls with cold thermal medium and finally unloading the mold. Clearly, the preheating step creates inefficiency in the process, in that the mold has to be opened twice to unload and load the half-molds.

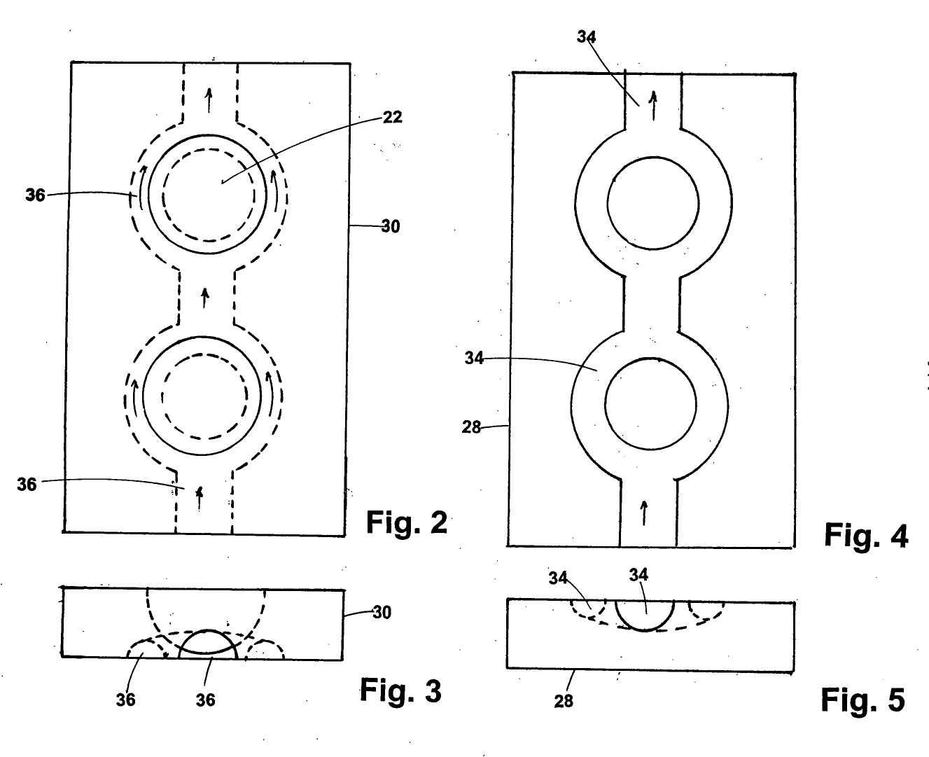

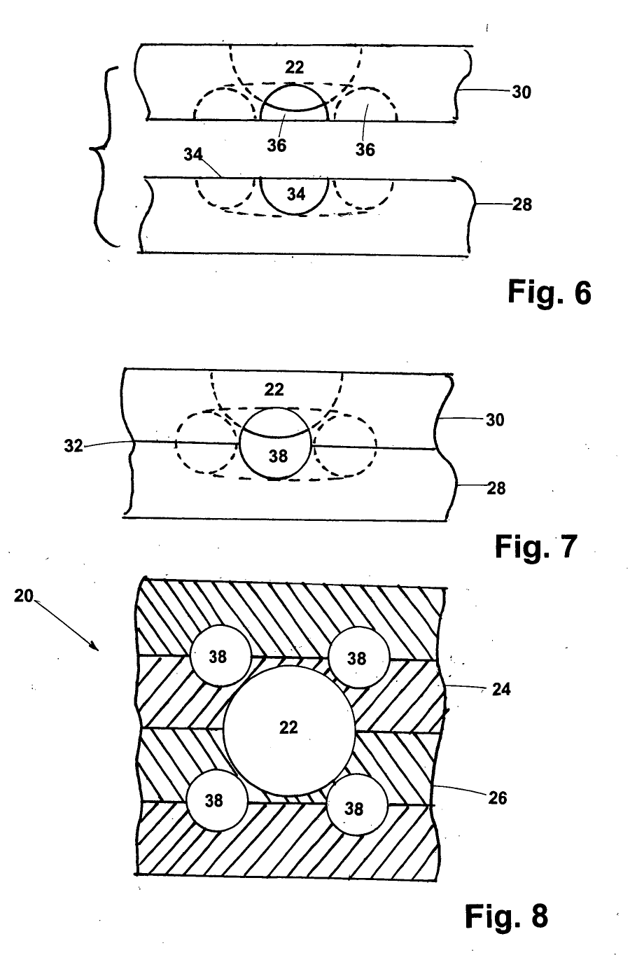

As shown in FIGS. 1-9, the mold frame 20 comprises a top half-mold 24 and a bottom half-mold 26, which are essentially mirror images of each other as best shown in FIG. 8. Each half-mold, 24, 26, is made up of a lower plate 28 and an upper plate 30 which are vacuum brazed together at point 32 as seen in FIGS. 6 and 7. For clarity, only two cavities 22 are shown in succession in FIGS. 2 and 4. It is to be appreciated that the actual number of cavities 22 is dependent upon the size and overall flow pattern of the mold frame 20. Prior to being brazed, a channel half portion 34 of a flow channel 38 is machined into the lower plate 28 by use of a ball end mill, and another channel half portion 36 of the flow channel 38 is machined into the upper plate 30. The mating surfaces of the plates 28 and 30 are mirror images of each other and are mated together by vacuum brazing such that the each half portion 34, 36, forms a single flow channel 38 through the half-molds 24, or 26. The flow channel 38 allows for the passage of thermal mediums, such as heating or cooling fluids, through the half-molds 24, 26, best seen in FIG. 8.

By fabricating a cooling or heating flow pattern as described in the present invention, the flow channels 38 can be as close to the cavities 22 as desired, thereby minimizing the distance the heat/cooling must transfer prior to transferring to the molded article and also the present design eliminates the need for O-rings. The final result is a quick thermal response.

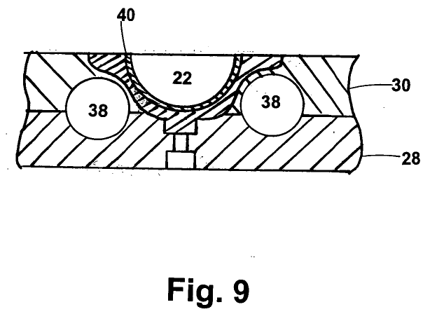

It does not affect the patentable aspect of the invention whether the mold frame 20 is used to mold golf ball cores or thermoplastic covers over a golf ball sub-assembly. The mold frame 20 is designed in such a way that in addition to the fast thermal response being created, the cavities 22 do not have the dimple configuration machined into the half-molds 24, 26, but rather the dimple configuration is contained in replaceable insert cups 40 (FIG.9), thereby making for an easy removal for changeover. And finally, the present invention provides a means of compression molding materials having higher melt temperatures than that of Surlyn.

In the prior art, compression mold designs which are used for the manufacture of golf ball cores, are generally limited to a hot process only (no cooling) and usually only transfer heat via thermal conduction between the half-molds. With the present invention the flow channels 38 can be placed as close to the cavities 22 as desired, resulting in a quick thermal response without the cooling/heating fluids being in direct contact with the cavity. The present invention also allows the flexibility for step curing cores and cooling them down prior to removing them from the cavities 22. By use of the proper chemistry, the present invention allows for a compression mold of a single solid core and producing a hardness gradient similar to a dual core (very hard outer, and to a certain degree. a soft inner).

Prior art equipment that is used for compression molding primarily is a hot to cold process (fast thermal response) and generally the temperature for molding is limited due to the use of O-rings which have been necessary for sealing fluids between the cavity wall and frame interface. The present invention, by machining the flow channels into the plates and then vacuum brazing them together, eliminates the need for O-rings. The most significant inventive aspect is thus the elimination of O-rings, therein allowing for the compression of thermoplastic materials above 300° F.

FIG. 9 depicts an embodiment of the invention wherein the cavity 22 contains a removable insert cup 40. This design allows for replacement of insert cups 40 on an individual basis when normal wear requires such, and eliminates the need to discard the entire frame 20.

It will be understood that the claims are intended to cover all changes and modifications of the preferred embodiments of the invention herein chosen for the purpose of illustration which do not constitute departures from the spirit and scope of the invention.

What is claimed is:

1. A mold frame for receiving golf ball sub-assemblies comprising:
a top half-mold and a bottom half-mold;
each half-mold having an upper and a lower plate vacuum brazed together;
a plurality of cavities defined in each upper plate;
channel half portions milled into each plate; and
flow channels defined by the mating of the upper and lower plates,
wherein a thermal medium flows through the flow channels in close proximity to the plurality of cavities to minimize heat transfer distance and eliminate need for O-rings.

2. The mold frame according to claim 1, wherein the mold frame is for molding golf ball cores.

3. The mold frame according to claim 1, wherein the mold frame is for molding thermoplastic covers over a golf ball sub-assembly.

4. The mold frames according to claim 1, wherein a replaceable insert cup is disposed in each cavity.

5. The mold frames according to claim 1, wherein the thermal medium is not in direct contact with any of the cavities.

6. The mold frames according to claim 1, wherein the compression molding of the thermoplastic materials is at a temperature greater than 300° F.

12. A mold frame for compression molding of golf balls comprising in combination:
a top half-mold and a bottom half-mold;
each half-mold having an upper and a lower plate vacuum brazed together;
a plurality of cavities defined in each upper plate, each cavity containing a replaceable insert cup therein;
channel half portions milled into each plate;
flow channels defined by the mating of the upper and lower plates;
thermal mediums flow through the flow channel in close proximity to the plurality of cavities to alternately heat or cool the cavities without the use of O-rings.

13. The mold frame according to claim 1, wherein the thermal medium is not in direct contact with any of the cavities.

14. The mold frame according to claim 1, wherein the compression molding of the thermoplastic materials is at temperatures greater than 300° F.

7. A mold frame for compression molding of thermal plastic articles comprising in combination:
a top half-mold and a bottom half-mold;
each half-mold having an upper and a lower plate vacuum brazed together;
a plurality of cavities defined in each upper plate, each cavity containing a replaceable insert cup therein;
channel half portions milled into each plate; and
flow channels defined by the mating of the upper and lower plates,
wherein a thermal medium flows through the flow channels in close proximity to the plurality of cavities to minimize heat transfer distance and eliminate need for O-rings.

8. The mold frame according to claim 1, wherein the plastic articles are golf ball cores.

9. The mold frame according to claim 8, wherein thermoplastic covers are molded over the golf ball cores.

10. The mold frame according to claim 1, wherein the thermal medium is not in direct contact with any of the cavities.

11. The mold frame according to claim 1, wherein the compression molding of the thermoplastic materials is at a temperature greater than 300° F.
